(19) United States
(12) Patent Application Publication
(10) Pub. No.: US 2026/0059294 A1
(43) Pub. Date: Feb. 26, 2026

(54) METHOD, COMMUNICATION DEVICE AND NON-TRANSITORY COMPUTER STORAGE MEDIUM FOR PROCESSING INFORMATION

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 19/103,427

(22) PCT Filed: Aug. 16, 2022
(86) PCT No.: PCT/CN2022/112883

§ 371 Date: Feb. 12, 2025

(51) Int. Cl. H04W 8/18; H04L 5/00

(52) U.S. Cl. CPC H04W 8/183; H04L 5/0053

(57) ABSTRACT

A method for processing information, includes: sending a delete request of the Internet of Things (IoT), where the delete request includes an identifier of the Internet of Things.

### CROSS-REFERENCE

The present application is a U.S. National Stage of International Application No. PCT/CN2022/112883, filed on Aug. 16, 2022, the contents of all of which are incorporated herein by reference in their entirety for all purposes.

### BACKGROUND OF THE INVENTION

The Internet of Things (IoT), also known as the Internet of Everything, is an extension and expansion of a network based on the Internet, in which various information sensing devices are integrated into the network to form a huge network that enables the interconnection of people, machines and things at any time and any location.

A Personal IoT Network (PIN) is a special type of IoT.

The PIN consists of PIN elements (PINEs), which communicate using PIN direct connection or direct network connection, and is managed locally (using a PIN element with management capability).

Specific types of the PINE may include: networks of wearables and smart home/smart office equipment.

Based on the capabilities of the PINE, the PINE may be divided into a PIN element with gateway capability (PEGC), a PIN element with management capability (PEMC), and a general PINE. The general PINE does not have gateway capability and management capability of the PIN.

### SUMMARY OF THE INVENTION

Examples of the present disclosure provide method, communication device and non-transitory computer storage medium for processing information.

In a first aspect of examples of the present disclosure, a method for processing information is provided. The method is performed by an Internet of things (IoT) management device or an IoT gateway device, and includes:
sending a delete request of IoT, where the delete request includes an identifier of the IoT.

In a second aspect of examples of the present disclosure, a method for processing information is provided. The method is performed by a core network device, and includes:
receiving a delete request of IoT.

In a third aspect of examples of the present disclosure, a communication device is provided. The communication device includes one or more processors, a transceiver, and a memory that stores an executable program, where the executable program when collectively executed by the one or more processors cause the communication device to send a delete request of IoT, where the delete request includes an identifier of the IoT.

In a fourth aspect of examples of the present disclosure, a non-transitory computer storage medium is provided, having an executable program stored thereon, where the executable program, when executed by one or more processors of the IoT management device, cause the IoT management device to perform the method for processing information provided in the first aspect.

In a fifth aspect of examples of the present disclosure, a communication device is provided. The communication device includes one or more processors, a transceiver, and a memory that stores an executable program, where the executable program when collectively executed by the one or more processors cause the communication device to act as the core network device and perform the method for processing information provided in the second aspect.

In a sixth aspect of examples of the present disclosure, a non-transitory computer storage medium is provided, having an executable program stored thereon, where the executable program, when executed by one or more processors of the core network device, cause the core network device to perform the method for processing information provided in the second aspect.

### BRIEF DESCRIPTION OF DRAWINGS

FIG. 1 is a schematic structural diagram of a wireless communication system shown according to an example;

FIG. 2A is a schematic flowchart of a method for processing information shown according to an example;

FIG. 2B is a schematic flowchart of a method for processing information shown according to an example;

FIG. 2C is a schematic flowchart of a method for processing information shown according to an example;

FIG. 2D is a schematic flowchart of a method for processing information shown according to an example;

FIG. 2E is a schematic flowchart of a method for processing information shown according to an example;

FIG. 3A is a schematic flowchart of a method for processing information shown according to an example;

FIG. 3B is a schematic flowchart of a method for processing information shown according to an example;

FIG. 3C is a schematic flowchart of a method for processing information shown according to an example;

FIG. 3D is a schematic flowchart of a method for processing information shown according to an example;

FIG. 3E is a schematic flowchart of a method for processing information shown according to an example;

FIG. 3F is a schematic flowchart of a method for processing information shown according to an example;

FIG. 4 is a schematic flowchart of a method for processing information shown according to an example;

FIG. 5 is a schematic structural diagram of a device for processing information shown according to an example;

FIG. 6 is a schematic structural diagram of a device for processing information shown according to an example;

FIG. 7 is a schematic structural diagram of PEMC or PEGC shown according to an example; and

FIG. 8 is a schematic structural diagram of a communication device shown according to an example.

### DETAILED DESCRIPTION OF THE INVENTION

The examples will be described in detail herein, and examples thereof are shown in the accompanying drawings. When the following description involves the accompanying drawings, unless otherwise indicated, the same numbers in different accompanying drawings indicate the same or similar elements. The implementations described in the following examples are not all the implementations consistent with the examples of the present disclosure. On the contrary, these implementations are simply examples of devices and methods consistent with some aspects of the examples of the present disclosure.

The terms used in the examples of the present disclosure are for the purpose of describing particular examples only and are not intended to limit the examples of the present disclosure. The singular forms “a/an” and “the” used in the present disclosure are intended to include the plural forms as well, unless the context clearly indicates otherwise. It should also be understood that the term “and/or” as used herein includes any and all combinations of one or more related listed items.

It should be understood that, although the terms “first,” “second,” “third,” etc., may be used to describe various information in the examples of the present disclosure, these should not be limited to these terms. These terms are only used to distinguish information of the same type from each other. For example, “first information” may also be referred to as “second information” without departing from the scope of the examples of the present disclosure. Similarly, “second information” may also be referred to as “first information”. Depending on the context, the words “if” as used here may be interpreted as “in the event of . . . ” or “when . . . ” or “in response to determining”.

The present disclosure relates to, but not limited to, the field of wireless communication technologies, in particular to method, communication device and non-transitory computer storage medium for processing information.

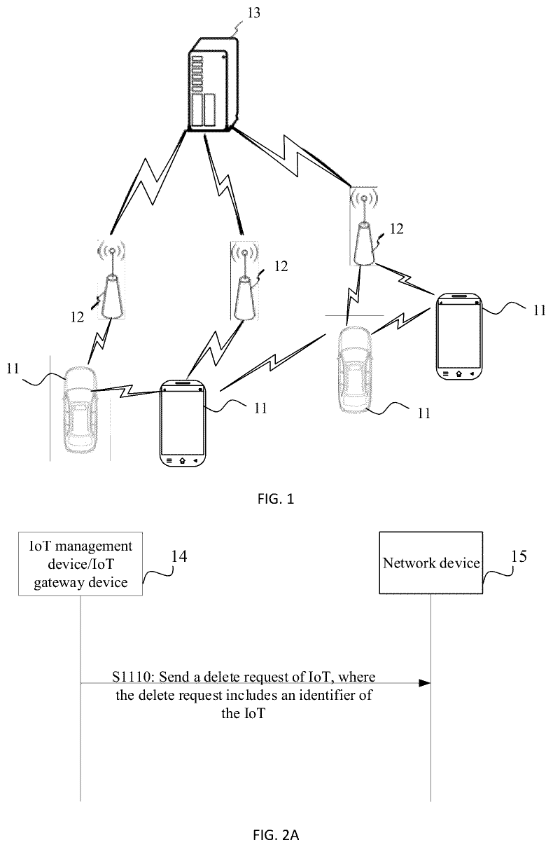

FIG. 1 illustrates a schematic structural diagram of a wireless communication system provided in an example of the present disclosure. As shown in FIG. 1, the wireless communication system is a communication system based on a cellular mobile communication technology. The wireless communication system may include a plurality of terminals 11 and a plurality of access devices 12.

The terminal 11 may refer to a device that provides voice and/or data connectivity for a user. The terminal 11 may communicate with one or more core networks via a radio access network (RAN). The terminal 11 may be an Internet of Things (IoT) terminal, such as a sensor device, a mobile phone (or a “cellular” phone) and a computer with an IoT terminal, which, for example, may be a fixed, portable, pocket-sized, handheld, or a device mounted in a computer or vehicle. For example, a station (STA), a subscriber unit, a subscriber station, a mobile station, a mobile, a remote station, an access point, a remote terminal, an access terminal, a user terminal, a user agent, a user device, or a user equipment (UE). Alternatively, the terminal 11 may also be a device for an unmanned aerial vehicle. Alternatively, the terminal 11 may also be a vehicle-mounted device, for example, may be an on-board computer with a wireless communication function, or a wireless communication device connected to an external on-board computer. Alternatively, the terminal 11 may also be a roadside device, such as a street lamp, a signal lamp or other roadside devices with a wireless communication function.

The access device 12 may be a network-side device in a wireless communication system. The wireless communication system may be a 4th generation mobile communication (4G) system, also known as a long term evolution (LTE) system; or the wireless communication system may also be a 5G system, also known as a new radio (NR) system or 5G NR system. Alternatively, the wireless communication system may be a next generation of the 5G system. An access network in the 5G system may be referred to as a new generation-radio access network (NG-RAN), or an MTC system.

The access device 12 may be an evolved access device (eNB) adopted in a 4G system. Alternatively, the access device 12 may also be an access device (gNB) with a centralized distributed architecture in the 5G system. The access device 12 generally includes a central unit (CU) and at least two distributed units (DU) in a case of adopting the centralized distributed architecture. The centralized unit is provided with a protocol stack of a packet data convergence protocol (PDCP) layer, a radio link control (RLC) protocol layer, and a media access control (MAC) layer; and the distribution unit is provided with a protocol stack of a physical (PHY) layer. The specific implementation of the access device 12 is not limited in the examples of the present disclosure.

A wireless connection may be established between the access device 12 and the terminal 11 via a radio interface. In different implementations, the radio interface is based on a 4th generation mobile communication network technology (4G) standard; or the radio interface is based on the 5th generation mobile communication network technology (5G) standard. For example, the radio interface is a new radio interface; or the radio interface may also be a radio interface based on a next generation mobile communication network technology standard of 5G.

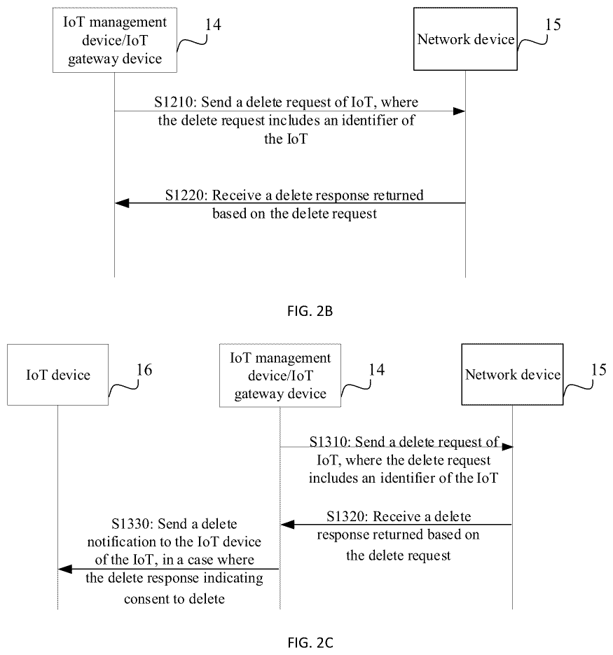

As shown in FIG. 2A, an example of the present disclosure provides a method for processing information. The method is performed by an Internet of things (IoT) management device or an IoT gateway device 14, and includes S1110.
S1110: sending a delete request of IoT to a network device 15, where the delete request includes an identifier of the IoT.

In the example of the present disclosure, the IoT network management device or the IoT gateway device may initiatively apply for deletion of IoT. For example, the PEMC or the PEGC may initiatively apply for the deletion of a PIN. The IoT includes, but is not limited to, a PIN.

For example, the user may build an IoT based on temporary network requirements, and trigger the PEMC or the PEGC to send the delete request by operating the PEMC or the PEGC when it is no longer needed. The delete request includes an identifier of the IoT requested for deletion. The delete request is equivalent to requesting the network device to delete corresponding IoT.

For example, the user may build a PIN based on temporary network requirements, and trigger the PEMC or the PEGC to send the delete request by operating the PEMC or the PEGC when it is no longer needed. The delete request includes an identifier of the PIN requested for deletion. The delete request is equivalent to requesting the network device to delete the corresponding PIN.

The network device includes, but is not limited to, a core network device. The core network device is not limited to unified data management (UDM) or unified data repository (UDR).

For example, the PEMC or PEGC is transmitted to the UDM or the UDR, etc., via a base station or other access network devices, and then via an access management function (AMF).

In this way, based on the technical solutions proposed in the examples of the present disclosure, the operations of the user based on the IoT network management device or the IoT gateway device are allowed, and the user can be allowed to delete IoT based on his/her wishes and needs, thereby satisfying the needs of IoT to be established and deleted at any time.

As shown in FIG. 2B, an example of the present disclosure provides a method for processing information. The method is performed by an IoT management device or an IoT gateway device 14, and includes S1210-S1220.
S1210: sending a delete request of IoT to a network device 15, where the delete request includes an identifier of the IoT; and
S1220: receiving a delete response returned by the network device 15 based on the delete request.

After receiving the delete request, the network device may send a corresponding delete response, where the delete response may indicate consent to delete IoT or refusal to delete IoT. That is, the delete response may be configured to indicate prohibiting deleting IoT or allowing to delete IoT.

In some examples, if there is subscription information with a communication operator in a process of establishing the IoT and the subscription information indicates that the IoT is a fixed-term network, deleting the IoT midway may be considered as a breach of contract, and then the delete response indicates refusal to delete the IoT.

In other examples, the delete response may further include: prompt information related to the deletion of the IoT, for example, compensation for the deletion of the IoT, and other possible consequences of the deletion of the IoT. If the user insists on deleting the IoT, the IoT may continue to be deleted, and the subsequent network devices will perform follow-up operations such as compensation after the IoT is deleted.

In summary, after sending the delete request to the network device, the PEGC or the PEMC may receive the delete response returned by a network-side device, so that the PEGC and/or the PEMC may perform operations related to the deletion of IoT based on the delete response.

For example, if the delete response indicates that the network device agrees to delete the IoT, the IoT management device or the IoT gateway device will delete locally stored Information of IoT, and/or notify other IoT devices to delete the IoT, and/or display a deletion prompt on a user interface (UI).

For another example, if the delete response indicates that the network device refuses to delete IoT, the IoT management device or the IoT gateway device will be temporarily configured to execute a delete notification of the IoT, and/or a display deletion failure on the UI. If the delete response contains a failure reason, the reason for deletion failure will be displayed on the IoT network management device or the IoT gateway device.

Through the receipt of the delete response, the IoT deletion process may be more complete and perfect, and the user experience can be improved.

In some examples, in a case that the IoT is a network of advance payment, the delete request may be a delete notification to the network device. In this case, after the IoT network management device or the IoT gateway device sends the delete request, the IoT network management device or the IoT gateway device will execute an IoT deletion operation without waiting for the delete response when the network device agrees to delete the IoT by default.

As shown in FIG. 2C, an example of the present disclosure provides a method for processing information. The method is performed by an IoT management device or an IoT gateway device 14, and includes S1310-S1330.
S1310: sending a delete request of IoT to a network device 15, where the delete request includes an identifier of the IoT;
S1320: receiving a delete response returned by the network device 15 based on the delete request; and
S1330: sending a delete notification to an IoT device of the IoT, in a case where the delete response indicating consent to delete.

In the example of the present disclosure, after receiving the delete response, the network device may send the delete notification to the IoT device of the IoT if it indicates consent to delete. If an execution device in the example of the present disclosure is an IoT management device, an IoT device receiving a PEMC delete notification may include: the IoT gateway device of the IoT and a general IoT device. If the execution device in the example of the present disclosure is an IoT gateway device, the IoT device receiving a delete notification for the IoT gateway device may include: the IoT management device of the IoT and a general IoT device. The general IoT device may be an IoT device other than the IoT gateway device and the IoT management device.

The delete notification may include at least an identifier of the IoT to be deleted. After receiving the delete notification, the IoT device may perform a deletion operation to realize the deletion of the IoT.

As shown in FIG. 2D, an example of the present disclosure provides a method for processing information. The method is performed by an IoT management device or an IoT gateway device 14, and includes S1410-S1440.
S1410: sending a delete request of IoT to a network device 15, where the delete request includes an identifier of the IoT;
S1420: receiving a delete response returned by the network device 15 based on the delete request;
S1430: sending a delete notification to an IoT device 16 of the IoT, in a case where the delete response indicating consent to delete; and
S1440: receiving acknowledgment (ACK) information sent by the IoT device 16.

In some examples, after receiving the delete notification, the IoT device knows that the IoT has been deleted and no ACK information needs to be returned. In the example of the present disclosure, the IoT device may return the ACK information. The ACK information is at least configured to indicate that the IoT device has received the delete notification, and/or that the IoT has been deleted.

In summary, upon the receipt of the ACK information, the PEMC and/or PEGC may be considered to have reached an agreement with other IoT devices to delete the IoT.

As shown in FIG. 2E, an example of the present disclosure provides a method for processing information. The method is performed by an IoT management device or an IoT gateway device 14, and includes S1510-S1530.
S1510: sending a delete request of IoT to a network device 15, where the delete request includes an identifier of the IoT;
S1520: receiving a delete response returned by the network device 15 based on the delete request; and
S1530: deleting information of the IoT stored by the IoT network management device or the IoT gateway device 14, in a case where the delete response indicating consent to delete.

After receiving the delete response, if the network device indicates consent to delete, the IoT network management device or the IoT gateway device may delete the Information of IoT locally.

For example, after receiving the delete response, if the network device indicates consent to delete, the PEMC or PEGC may delete the PIN information locally.

For example, the Information of IoT may include, but is not limited to, at least one of:
an identifier of the IoT;
a login account for the IoT;
a connection password for the IoT;
an identifier of the IoT management device of the IoT;
an identifier of the IoT gateway device of the IoT; or
an identifier of the general IoT device of the IoT, etc.

For example, the PIN information may include, but is not limited to, at least one of:
an identifier of the PIN;
a login account for the PIN;
a connection password for the PIN;
an identifier of the PEMC of the PIN;
an identifier of the PEGC of the PIN; or
an identifier of the general PINE of the PIN, etc.

Certainly, the above are only examples of the Information of IoT, and the specific implementation is not limited to the above examples.

In some examples, the delete response has a consent mark indicating consent to delete; or the delete response has a refusal mark indicating refusal to delete.

The consent mark and the refusal mark may be different bit values for one indication field. The indication field includes one or more bits. When the one or more bits have different bit values, they represent the consent mark or the refusal mark, respectively. The consent mark may also be referred to as a success mark. The refusal mark may also be referred to as a failure mark.

In another example, the consent mark and the refusal mark may correspond to different fields, and one field may include one or more bits. In this way, the consent mark and the refusal mark may be carried by different fields in the delete response.

After the delete response indicating consent to delete is received, the steps of the IoT management device or the IoT gateway device deleting the Information of IoT locally and of sending the delete notification to the IoT device are not executed in a specified sequence. For example, the IoT management device or the IoT gateway device first sends the delete notification to the IoT device and then deletes the locally stored Information of IoT; or receive the ACK information returned by the IoT device first, and then deletes the locally stored Information of IoT. Alternatively, the IoT management device or the IoT gateway device deletes the locally stored Information of IoT first, and then sends a notification to the IoT device.

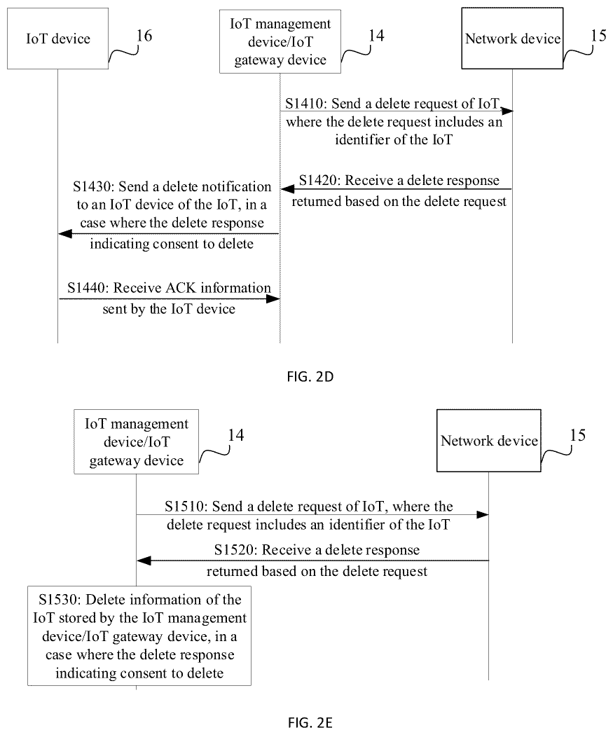

As shown in FIG. 3A, an example of the present disclosure provides a method for processing information. The method is performed by a core network device 17, and includes S2110.
S2110: receiving a delete request of IoT sent by an IoT management device or an IoT gateway device 14, where the delete request includes an identifier of the IoT.

The core network device includes, but is not limited to, the core network device. The core network device includes, but is not limited to,
PIN management function (PMF) or unified data management (UDM).

The IoT includes, but is not limited to, a PIN.

For example, if the PMF stores Information of IoT and fully manages the IoT, the PMF may receive the delete notification via a base station and/or an AMF.

The Information of IoT may also exist in the UDM, and the UDM receives the delete request directly via the base station and the AMF.

In other examples, the PMF manages the IoT, but IoT data is stored in the UDM, so that the IoT receives a delete request sequentially forwarded or transparently forwarded by the base station and the AMF, and then sends the delete request to the UDM.

The PMF, the UDM, and the AMF are all network elements of a core network.

As shown in FIG. 3B, an example of the present disclosure provides a method for processing information. The method is performed by a core network device 17, and includes S2210-S2220:
S2210: receiving a delete request of IoT sent by an IoT management device or an IoT gateway device 14; and
S2220: deleting the Information of IoT stored by the core network device 17 based on the delete request.

In the example of the present disclosure, after the PMF or UDM receives the delete request, the PMF and/or UDM may delete the Information of IoT locally in response to consent to delete.

The Information of IoT may include at least one of:
an identifier of the IoT;
a login account for the IoT;
a connection password for the IoT;
an identifier of the IoT management device of the IoT;
an identifier of the IoT gateway device of the IoT; or
an identifier of the general IoT device of the IoT, etc.

For example, the PIN information may include at least one of:
an identifier of the PIN;
a login account for the PIN;
a connection password for the PIN;
an identifier of the PEMC of the PIN;
an identifier of the PEGC of the PIN; or
an identifier of the general PINE of the PIN, etc.

In other examples, in response to consent to delete the IoT, the delete notification is also sent to a policy control function (PCF), etc., based on billing and quality of service (QoS) of the IoT, so that the PCF deletes policy information of the IoT.

It is worth noting that: if the PMF or UDM refuses to delete the IoT, the core network device such as the PMF or UDM will not delete the locally stored Information of IoT.

As shown in FIG. 3C, an example of the present disclosure provides a method for processing information. The method is performed by a core network device 17, and includes S2310-S2320.
S2310: receiving a delete request of the IoT sent by an IoT management device or an IoT gateway device 14; and
S2320: returning a delete response to the IoT management device or an IoT gateway device 14 based on the delete request.

In the example of the present disclosure, the core network device such as the PMF or UDM may return the delete response based on whether they agree to delete the IoT. The delete response may be forwarded or transparently transmitted to the PEMC or PEGC via the AMF and the base station.

The delete response may indicate consent to delete the IoT or refusal to delete the IoT (i.e., disagreement with deleting the IoT).

For example, if the validity period of the IoT has not expired, the deletion of the IoT may be refused; or if the IoT is fixed-term IoT based on subscription information and a compensation is required for deletion midway, the delete response indicating refusal to delete the IoT will be returned.

For another example, if the DUM or PMF determines that there is no refusal to delete, the IoT may be deleted at the same time, and the delete response indicating consent to delete may be forwarded or transparently transmitted to the PEMC or PEGC via the AMF or the base station.

In some examples, the method further includes:
determining whether the PEGC or PEMC has a permission to delete the IoT subject to authentication;
determining whether to agree to delete the IoT to obtain a determination result when the authentication is successful; and
returning the delete response based on the determination result.

For example, whether the IoT gateway device or the IoT network management device has a permission to delete the IoT based on subscription data of the IoT; and if the IoT gateway device or the IoT network management device currently sending the delete notification is not an IoT gateway device or an IoT network management device of IoT to be deleted, and the subscription data indicates that only the IoT gateway device or IoT network management device has a delete permission, refusal to delete is determined. For another example, if the subscription data explicitly indicates that the deletion of the IoT requires a store to acknowledge the deletion of the IoT, such a delete request of online IoT may also be refused.

Specifically, the IoT gateway device or the IoT network management device such as the PEGC or the PEMC may be authenticated as follows.

As shown in FIG. 3D, an example of the present disclosure provides a method for processing information. The method is performed by a core network device 17, and includes S2410-S2420.
S2410: receiving a delete request of IoT sent by an IoT management device or an IoT gateway device 14; and
S2420: returning a delete response indicating consent to delete when an IoT management device or an IoT gateway device 14 sending the delete request has a delete permission.

As shown in FIG. 3E, an example of the present disclosure provides a method for processing information. The method is performed by a core network device, and includes S2510-S2520.
S2510: receiving a delete request of IoT sent by an IoT management device or an IoT gateway device 14; and
S2520: returning a delete response indicating refusal to delete when an IoT management device or an IoT gateway device 14 sending the delete request does not have a delete permission.

As shown in FIG. 3F, an example of the present disclosure provides a method for processing information. The method is performed by a core network device 17, and includes S2610-S2630.
S2610: receiving a delete request of IoT sent by an IoT management device or an IoT gateway device 14;
S2620: determining whether to delete the IoT to obtain a determination result based on subscription information of the IoT when an IoT management device or an IoT gateway device 14 sending the delete request does not have a delete permission; and
S2630: returning a delete response indicating refusal to delete or consent to delete to the IoT management device or the IoT gateway device 14 based on the determination result.

In summary, in the example of the present disclosure, whether the IoT management device or the IoT gateway device has the delete permission is also one of reference factors for the core network device, such as the UDM or the PMF, to refuse or agree to delete the IoT.

In some examples, the delete response has a consent mark indicating consent to delete; or the delete response has a refusal mark indicating refusal to delete.

In the example of the present disclosure, the delete response indicating consent to delete and the delete response indicating refusal to delete may have the same quantity of messages, and the content within the message indicates whether to agree to delete.

In another example, the delete response indicating consent to delete and the delete response indicating refusal to delete have different message formats, so that the message format implicitly indicates consent to delete and refusal to delete.

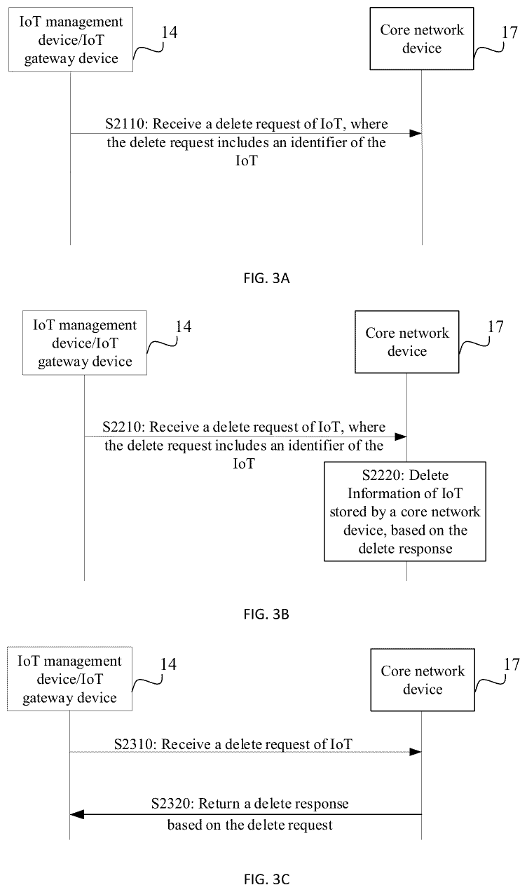

As shown in FIG. 4, an example of the present disclosure provides a method for processing information. The method may include the following steps 1-8.
1. The PEMC 18 sends a delete request of the PIN to the AMF 20 via gNB 19, where the delete request may include a PIN ID and a PEMC ID;

2. the AMF 20 sends a delete request of the PIN to the PMF/UDM 21, where the delete request may include a PIN ID and a PEMC ID;
3. the PMF/UDM 21 deletes PIN information, where the PMF/UDM may optionally verify whether the PEMC has a permission to delete a PIN;
4. the PMF/UDM 21 sends a PIN delete response to the AMF 20, including a success mark or a failure mark;
5. the AMF 20 sends a PIN delete response to the PEMC 18 via gNB 19, including a success mark or a failure mark;
6. the PEMC 18 sends a delete notification of the PIN to the PINE 22;
7. the PINE(s) 22 send(s) PIN delete ACK to the PEMC 18; and
8. the PEMC(s) 18 delete(s) all PIN information. The step may be executed after step 5.

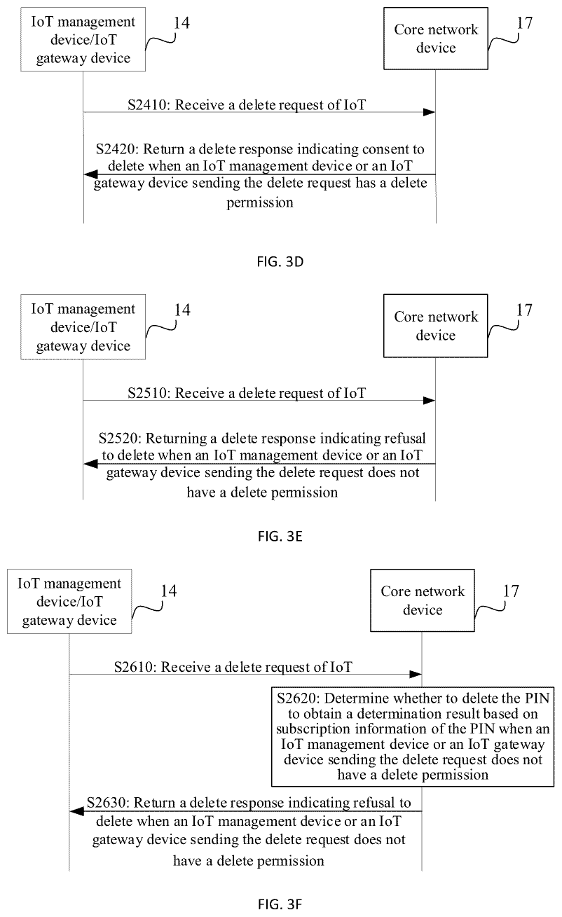

As shown in FIG. 5, an example of the present disclosure provides a device 100 for processing information. The device 100 includes a first sending module 110.

The first sending module 110, configured to send a delete request of IoT, where the delete request includes an identifier of the IoT.

The device for processing information may be an IoT management device or an IoT gateway device. For example, the IoT is a PIN, and the IoT gateway device or the IoT management device may be a PEGC or a PEMC, etc.

The first sending module 110 may correspond to a transmitting/receiving antenna and/or a network interface.

In the example of the present disclosure, the device 100 for processing information further includes a storage module (not shown). The storage module may include one or more memories, which may be at least configured to store the delete request.

In some examples, the first sending module 110 may be a program module. The program module may implement the above operations when executed by a processor.

In other examples, the first sending module 110 may further include a module combining hardware and software. The module in which hardware and software are combined includes, but is not limited to: a programmable array. The programmable array may include a field-programmable array and/or a complex programmable array.

In other examples, the first sending module 110 may be a pure hardware module. The pure hardware module includes, but is not limited to an integrated circuit.

In some examples, the device 100 may further include a storage module. The storage module is connected to the first sending module 110. The storage module may be configured to store a delete request.

In some examples, the device 100 further includes:
a first receiving module (not shown), configured to receive a delete response returned based on the delete request.

In some examples, the device 100 further includes:
the first sending module 110 is further configured to send a delete notification to an IoT device of the IoT in a case where the delete response indicating consent to delete.

In some examples, the first receiving module is configured to receive acknowledgement (ACK) information sent by the IoT device.

In some examples, the device 100 further includes:
a first deletion module (not shown), configured to delete information of the IoT stored by the IoT management device or the IoT gateway device in a case where the delete response indicating consent to delete.

In some examples, the delete response has a consent mark indicating consent to delete;
or
the delete response has a refusal mark indicating refusal to delete.

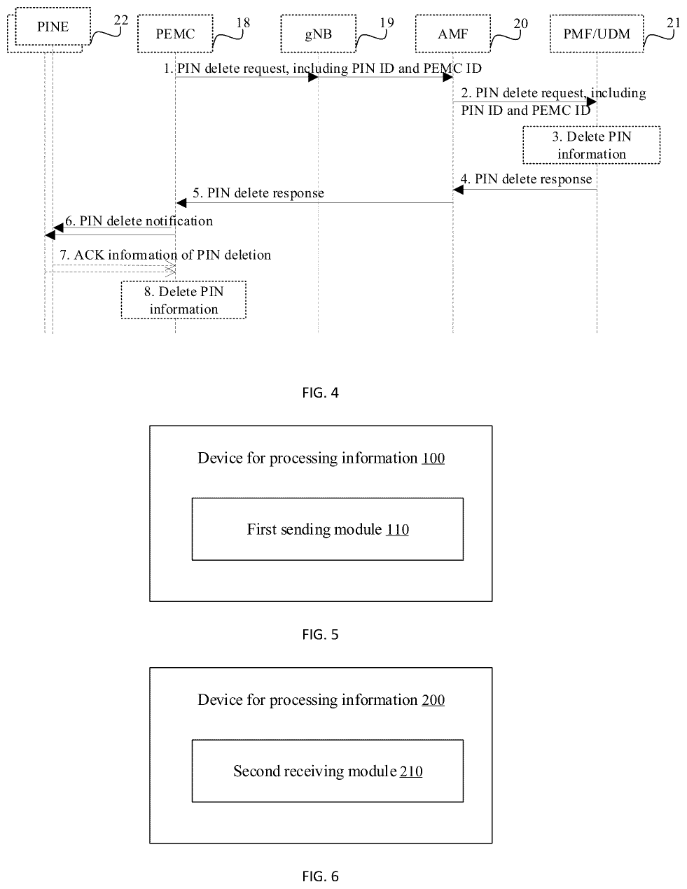

As shown in FIG. 6, an example of the present disclosure provides a device 200 for processing information. The device 200 includes a second receiving module 210.

The second receiving module 210, configured to receive a delete request of IoT.

The device 200 for processing information may be a core network device such as PMF or UDM.

The second receiving module 210 may be a transmitting/receiving antenna and/or a network interface.

In the example of the present disclosure, the device 200 for processing information further includes a storage module (not shown). The storage module may include one or more memories, which may be at least configured to store the delete request.

In some examples, the second receiving module 210 may be a program module. The program module may implement the above operations when executed by a processor.

In other examples, the second receiving module 210 may further include a module in which hardware and software are combined. The module in which hardware and software are combined includes, but is not limited to: a programmable array. The programmable array may include a field-programmable array and/or a complex programmable array.

In other examples, the second receiving module 210 may be a pure hardware module. The pure hardware module includes, but is not limited to: an integrated circuit.

In some examples, the device 200 may further include a storage module. The storage module is connected to the second receiving module 210. The storage module may be configured to store a delete request.

In some examples, the device 200 further includes:
a second deletion module (not shown), configured to delete the Information of IoT stored by the core network device based on the delete request.

In some examples, the device 200 further includes:
a second sending module (not shown), configured to return a delete response based on the delete request.

In some examples, the second sending module is configured to return the delete response indicating consent to delete when an IoT management device or an IoT gateway device sending the delete request has a delete permission;
or
return the delete response indicating refusal to delete when an IoT management device or an IoT gateway device sending the delete request does not have a delete permission.

In some examples, the delete response has a consent mark indicating consent to delete;
or
the delete response has a refusal mark indicating refusal to delete.

In some examples, the second receiving module 210 is configured to receive the delete request sequentially forwarded or transparently transmitted by a base station and an access management function (AMF).

An example of the present disclosure provides a communication device. The communication device includes:
a memory, configured to store instructions executable by a processor; and
the processor, connected to the memory, where
the processor is configured to perform the method for processing information provided in any of the above technical solutions.

The processor may include various types of storage media. The storage media may be non-transitory computer storage media that can continue to memorize information stored thereon after the communication device is powered off.

Here, the communication device includes: a PEMC, a PEGC or a network device. The network device may be PMF or UDM.

The processor may be connected to the memory via a bus, etc., and configured to read an executable program stored on the memory, for example, at least one of the methods shown in FIG. 2A to FIG. 2E, FIG. 3A to FIG. 3F, or FIG. 4.

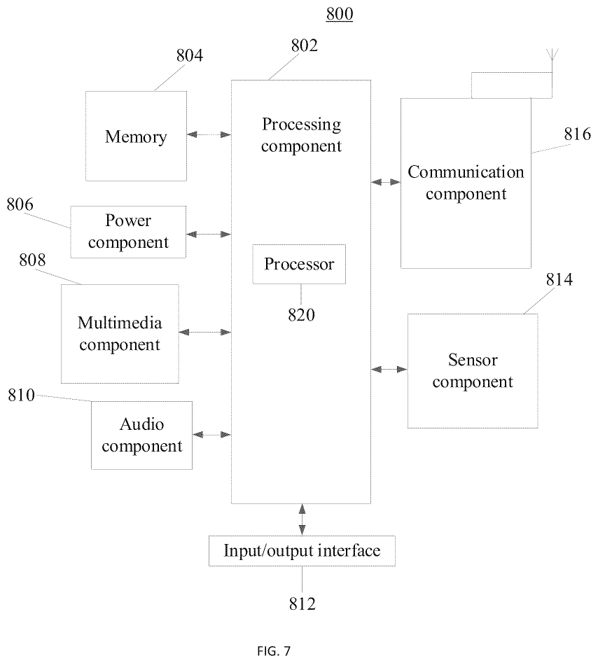

FIG. 7 is a block diagram of a PEMC or PEGC 800 shown according to an example. For example, the PEMC or PEGC 800 may be a mobile phone, a computer, a digital broadcast terminal device, a message transceiver device, a game console, a tablet device, a medical device, a fitness device, a personal digital assistant, or the like.

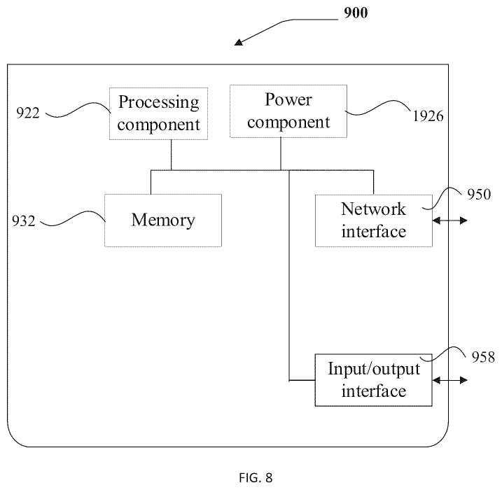

Referring to FIG. 8, the PEMC or PEGC 800 may include one or more of a processing component 802, a memory 804, a power component 806, a multimedia component 808, an audio component 810, an input/output (I/O) interface 812, a sensor component 814, and a communication component 816.

The processing component 802 typically controls overall operations of the PEMC or PEGC 800, such as the operations associated with display, telephone calls, data communications, camera operations, and recording operations. The processing component 802 may include one or more processors 820 to execute instructions to complete all or part of the steps of the method described above. In addition, the processing component 802 includes one or more modules to facilitate interaction between the processing component 802 and other components. For instance, the processing component 802 may include a multimedia module to facilitate the interaction between the multimedia component 808 and the processing component 802.

The memory 804 is configured to store various types of data to support the operation of the PEMC or PEGC 800. Examples of such data include instructions for any applications or methods operated on the PEMC or PEGC 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 806 provides power for various components of the PEMC or PEGC 800. The power component 806 may include a power management system, one or more power sources, and any other components associated with the generation, management, and distribution of power in the PEMC or PEGC 800.

The multimedia component 808 includes a screen providing an output interface between the PEMC or PEGC 800 and the user. In some examples, the screen may include a liquid crystal display (LCD) and a touch panel (TP). If the screen includes a touch panel, the screen may be implemented as a touch screen to receive input signals from a user. The TP includes one or more touch sensors to sense touch, swipe, and gestures on the touch panel. The touch sensors may not only sense a boundary of a touch or swipe action, but also sense a duration and a pressure associated with the touch or swipe action. In some examples, the multimedia component 808 includes a front camera and/or a rear camera. The front camera and/or the rear camera may receive external multimedia data while the PEMC or PEGC 800 is in an operation mode, such as a photographing mode or a video mode. Each of the front camera and the rear camera may be a fixed optical lens system or have focus and optical zoom capabilities.

The audio component 810 is configured to output and/or input audio signals. For example, the audio component 810 includes a microphone (“MIC”) configured to receive an external audio signal when the PEMC or PEGC 800 is in an operation mode, such as a call mode, a recording mode, and a voice recognition mode. The received audio signal may be further stored in the memory 804 or transmitted via the communication component 816. In some examples, the audio component 810 further includes a speaker configured to output audio signals.

The I/O interface 812 provides an interface between the processing component 802 and peripheral interface modules, such as a keyboard, a click wheel, buttons, and the like. These buttons may include, but are not limited to, a home button, a volume button, a starting button, and a locking button.

The sensor component 814 includes one or more sensors that are configured to provide state estimations in various aspects for the PEMC or PEGC 800. For instance, the sensor component 814 may detect an on/off state of the PEGC 800, relative positioning of components, e.g., the display and the keypad, of the PEMC or PEGC 800, a change in position of the PEMC or PEGC 800 or a component of the PEMC or PEGC 800, a presence or absence of user contact with the PEMC or PEGC 800, an orientation or an acceleration/deceleration of the PEMC or PEGC 800, and a change in temperature of the PEMC or PEGC 800. The sensor component 814 may include a proximity sensor configured to detect the presence of nearby objects without any physical contact. The sensor component 814 may also include a light sensor, such as a CMOS or CCD image sensor, for use in imaging applications. In some examples, the sensor component 814 may also include an accelerometer sensor, a gyroscope sensor, a magnetic sensor, a pressure sensor, or a temperature sensor.

The communication component 816 is configured to facilitate wired or wireless communication between the PEMC or PEGC 800 and other devices. The PEMC or PEGC 800 may access a wireless network based on a communication standard, such as WiFi, 2G, or 3G, or a combination thereof. In an example, the communication component 816 receives a broadcast signal or broadcast associated information from an external broadcast management system via a broadcast channel. In an example, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the PEMC or PEGC 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In an example, a non-transitory computer-readable storage medium including instructions is further provided, such as a memory 804 including instructions, which may be executed by a processor 820 of the PEMC or PEGC 800 to generate the above methods. For example, the non-transitory computer-readable storage medium may be a ROM, a random-access memory (RAM), a compact disc read-only memory (CD-ROM), a magnetic tape, a floppy disk, and/or an optical data storage device, etc.

As shown in FIG. 8, an example of the present disclosure shows a structure of an access device. For example, a communication device 900 may be provided as a network-side device. The communication device may be the PEMC, PEGC or network device. The network device includes, but is not limited to, PMF or UDM.

Referring to FIG. 8, the communication device 900 includes a processing component 922 which further includes one or more processors, and memory resources represented by a memory 932 for storing instructions executable by the processing component 922, such as applications. The applications stored in the memory 932 may include one or more modules, each corresponding to a set of instructions. In addition, the processing component 922 is configured to execute instructions to implement any method applied in the access device described in the above methods, e.g., at least one of the methods shown in FIG. 2A to FIG. 2E, FIG. 3A to FIG. 3F, or FIG. 4.

The communication device 900 may further include a power component 1926 configured to perform power management of the communication device 900, one or more wired or wireless network interfaces 950 configured to connect the communication device 900 to a network, and one or more input/output (I/O) interfaces 958. The communication device 900 may operate based on an operating system stored in the memory 932, such as Windows Server™, Mac OS X™, Unix™, Linux™, FreeBSD™ or analogs.

According to the technical solutions provided in the examples of the present disclosure, the IoT network management device or the IoT gateway device may send the delete request to the network device so as to request the deletion of IoT. In this way, the operations of the user based on the IoT network management device or the IoT gateway device are allowed, and the user can be allowed to delete IoT based on his/her wishes and needs, thereby satisfying the needs of IoT to be established and deleted at any time.

It should be understood that the above general description and detailed description are only exemplary and illustrative, and not intended to limit the examples of the present disclosure.

Other examples of the present disclosure will be apparent to those skilled in the art from consideration of the specification and to practice the present disclosure herein. The present disclosure is intended to cover any variations, uses, or adaptations of the present disclosure, following the general principles thereof and including common knowledge or commonly used technical means which are not disclosed herein. The specification and examples are to be considered as examples only, and the true scope and spirit of the present disclosure are indicated by the following claims.

It will be appreciated that the present disclosure is not limited to the exact construction that has been described above and illustrated in the accompanying drawings, and that various modifications and changes can be made without departing from the scope thereof. The scope of the present disclosure is only limited by the appended claims.

1. A method for processing information, performed by an Internet of things (IoT) management device or an IoT gateway device, comprising:
sending a delete request of IoT, wherein the delete request comprises an identifier of the IoT.

2. The method according to claim 1, wherein the method further comprises:
receiving a delete response returned based on the delete request.

3. The method according to claim 2, wherein the method further comprises:
sending a delete notification to an IoT device of the IoT, in a case where the delete response indicating consent to delete.

4. The method according to claim 3, wherein the method further comprises:
receiving acknowledgement information sent by the IoT device.

5. The method according to claim 2, wherein the method further comprises:
deleting information of the IoT stored by the IoT management device or the IoT gateway device, in a case where the delete response indicating consent to delete.

6. The method according to claim 2, wherein the delete response has a consent mark indicating consent to delete.

7. A method for processing information, performed by a core network device, comprising:
receiving a delete request of Internet of things (IoT).

8. The method according to claim 7, wherein the method further comprises:
deleting information of the IoT stored by the core network device based on the delete request.

9. The method according to claim 7, wherein the method further comprises:
returning a delete response based on the delete request.

10. The method according to claim 9, wherein returning the delete response based on the delete request comprises:
returning a delete response indicating consent to delete, in a case where an IoT management device or an IoT gateway device sending the delete request has a delete permission.

11. The method according to claim 7, wherein
the delete response has a consent mark indicating consent to delete.

12. The method according to claim 7, wherein receiving the delete request of the IoT comprises:
receiving the delete request sequentially forwarded or transparently transmitted by a base station and an access management function (AMF).

13.-24. (canceled)

25. A communication device, comprising:
one or more processors,
a transceiver, and
a memory that stores an executable program,
wherein the executable program when collectively executed by the one or more processors cause the communication device to send a delete request of IoT, wherein the delete request comprises an identifier of the IoT.

26. A non-transitory computer storage medium, having an executable program stored thereon, wherein the executable program, when executed by one or more processors of the IoT management device, cause the IoT management device to perform the method according to claim 1.

27. The method according to claim 2, wherein the delete response has a refusal mark indicating refusal to delete.

28. The method according to claim 9, wherein returning the delete response based on the delete request comprises:
returning a delete response indicating refusal to delete, in a case where an IoT management device or an IoT gateway device sending the delete request does not have a delete permission.

29. The method according to claim 7, wherein the delete response has a refusal mark indicating refusal to delete.

30. A communication device, comprising:
one or more processors,
a transceiver, and
a memory that stores an executable program,
wherein the executable program when collectively executed by the one or more processors cause the communication device to act as the core network device and perform the method according to claim 7.

31. The communication device according to claim 25, wherein the one or more processors further perform:
receiving a delete response returned based on the delete request.

32. A non-transitory computer storage medium, having an executable program stored thereon, wherein the executable program, when executed by one or more processors of the core network device, cause the core network device to perform the method according to claim 7.
